(19) United States
(12) Patent Application Publication
(10) Pub. No.: US 2012/0014664 A1
(43) Pub. Date: Jan. 19, 2012

(54) RECORDING CONTROL APPARATUS AND RECORDING CONTROL METHOD

(75) Inventor: Shinichiro MANABE, Ageo-shi (JP)

(73) Assignee: KABUSHIKI KAISHA TOSHIBA, Tokyo (JP)

(21) Appl. No.: 13/184,372

(22) Filed: Jul. 15, 2011

(30) Foreign Application Priority Data
Jul. 16, 2010 (JP) 2010-162164

(51) Int. Cl. H04N 9/80

(52) U.S. Cl. 386/248; 386/E09.011

(57) ABSTRACT

According to one embodiment, a recording control apparatus includes a setup module and a controller. The setup module is configured to set, in accordance with designation of a device, an adaptive data format which is adaptive to the device. The controller is configured to execute control to record input data by the adaptive data format.

### CROSS-REFERENCE TO RELATED APPLICATIONS

This application is based upon and claims the benefit of priority from Japanese Patent Application No. 2010-162164, filed Jul. 16, 2010; the entire contents of which are incorporated herein by reference.

### FIELD

Embodiments described herein relate generally to a recording control apparatus and a recording control method, which execute control to record input data.

### BACKGROUND

In recent years, a recording/reproducing apparatus, which can record and reproduce digital TV broadcast, have been gaining in popularity. This recording/reproducing apparatus can record digital TV broadcast in a hard disk drive (HDD) or a digital versatile disk (DVD).

Further, there has been proposed a recording/reproducing apparatus which can record digital TV broadcast in a card-type recording medium such as an SD memory card. By recording video content in an SD memory card by this recording/reproducing apparatus, it becomes possible to reproduce the video content recorded in the SD memory card by an external device, such as a mobile terminal, which supports SD memory cards.

In the above-described recording/reproducing apparatus, video content is recorded in the SD memory card by a pre-designated data format. If the external device does not support the designated data format, the external device cannot reproduce the video content recorded in the SD memory card.

In order to avoid this situation, for example, the user checks the adaptive data format which is adaptive to the external device, and sets up the recording/reproducing apparatus so as to record the video content in the SD memory card by the adaptive data format. This setup operation is time-consuming for the user. Besides, this setup operation is difficult for users who are not familiar with data formats.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a device-adaptive format select OSD screen;

FIG. 2 is a flow chart illustrating an example of a first adaptive data format setup process;

FIG. 3 is a flow chart illustrating an example of a second data recording process for recording content data by both a standard data format and an adaptive data format;

FIG. 4 shows an example of a correspondency table; and

FIG. 5 is a block diagram illustrating a schematic structure of a video recording/reproducing apparatus (recording control apparatus) according to first to fourth embodiments.

### DETAILED DESCRIPTION

Various embodiments will be described hereinafter with reference to the accompanying drawings.

In general, according to one embodiment, a recording control apparatus includes a setup module and a controller. The setup module is configured to set, in accordance with designation of a device, an adaptive data format which is adaptive to the device. The controller is configured to execute control to record input data by the adaptive data format.

First to fourth embodiments will now be described with reference to the accompanying drawings.

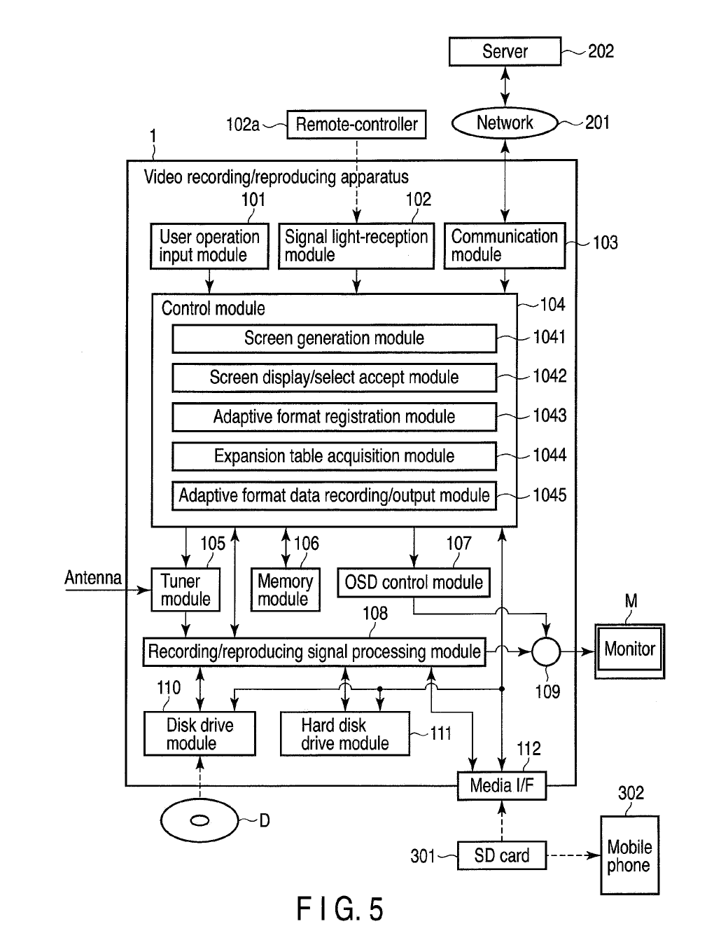

FIG. 5 is a block diagram illustrating a schematic structure of a video recording/reproducing apparatus (recording control apparatus) according to the first to fourth embodiments. In the first to fourth embodiments, a device-adaptive recording process by the video recording/reproducing apparatus is described. The embodiments, however, are not limited to the device-adaptive recording process by the video recording/reproducing apparatus. For example, the device-adaptive recording process, which is described in the first to fourth embodiments, is applicable to a digital broadcast receiver (digital TV) having a recording function.

As shown in FIG. 5, a video recording/reproducing apparatus 1 comprises a user operation input module 101, a signal light-reception module 102, a communication module 103, a control module (CPU) 104, a tuner module 105, a memory module 106, an OSD control module 107, a recording/reproducing signal processing module 108, a mixing process module 109, a disk drive module 110, a hard disk drive module 111, and a media interface 112.

The control module 104 controls an operation of recording a program and an operation of reproducing a program. In addition, the control module 104 controls execution of a device-adaptive recording process which will be described later. The communication module 103 can be connected to a server 202 via a network 201, and can transmit various information to the server 202 and receive various information from the server 202. The tuner module 105 selects a broadcast signal of a designated channel, and inputs the selected broadcast signal to the recording/reproducing signal processing module 108.

When a recording process is designated, the recording/reproducing signal processing module 108 inputs program content data (video signal and audio signal) corresponding to the broadcast signal to at least one of the disk drive module 110, hard disk drive module 111 and media interface 112.

The disk drive module 110 records input program content data on an optical disk D, such as a DVD or a BD (Blu-ray) (trademark), in a standard data format (default data format) which is adaptive to a medium that is a target of recording. Specifically, when program content data is recorded on a DVD, the disk drive module 110 records the program content data on the DVD by a predetermined data format (standard data format) which is adaptive to DVD specifications. When program content data is recorded on a BD, the disk drive module 110 records the program content data on the BD by a predetermined data format (standard data format) which is adaptive to BD specifications.

Similarly, the hard disk drive module 111 records input program content data in a hard disk by a standard data format (default data format) which is adaptive to a medium that is a target of recording.

The media interface 112 records, according to the device-adaptive recording process, input program content data in media (e.g. an SD card 301) by a device-adaptive data format. The device-adaptive recording process will be described later in detail.

For example, a mobile terminal 302 includes a media slot for the SD card 301, and the mobile terminal 302 supports one or a plurality of data formats. Hereinafter, a data format which is supported by the mobile terminal 302 is referred to as “support data format”. Specifically, the mobile terminal 302 can reproduce program content data of a support data format, which is recorded in the SD card 301, but cannot reproduce program content data of a non-support data format, which is recorded in the SD card 301.

When a reproduction process is designated, the recording/reproducing signal processing module 108 outputs program content data corresponding to a broadcast signal to a video display device M (digital TV) including a speaker or the like, via the mixing process module 109.

Next, an example of various operations through a remote-controller 102a is described. Various operations through the user operation input module 101 are substantially identical to various operations through the remote-controller 102a, and thus a description of the former is omitted.

The remote-controller 102a includes a plurality of keys, and transmits instructions which are input through these keys. The signal light-reception module 102 receives an instruction from the remote-controller 102a, and notifies the instruction to the control module 104.

Next, the device-adaptive recording process is described.

### First Embodiment

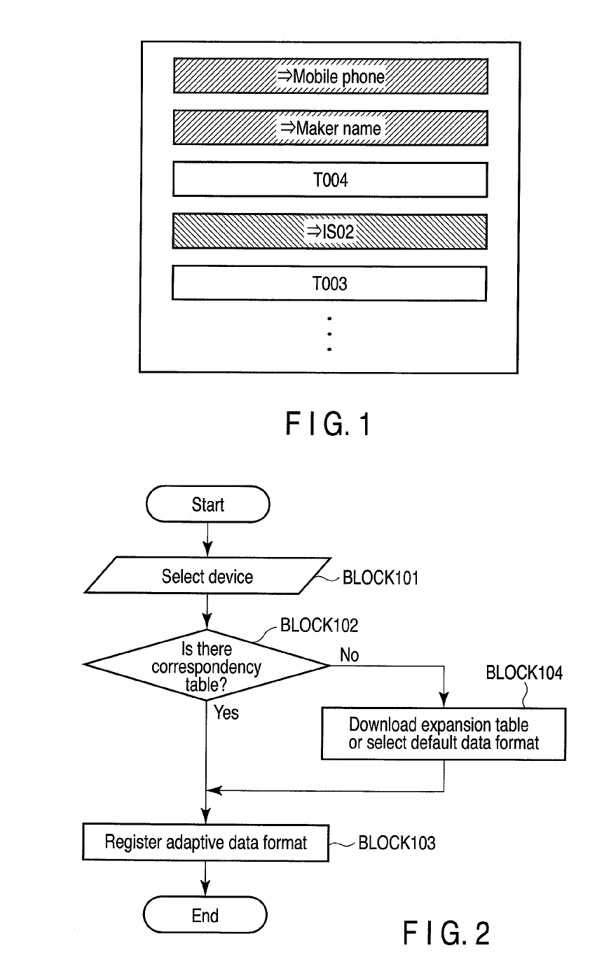

To begin with, referring to FIG. 1 and FIG. 2, a device designation process is described, and further a first adaptive data format setup process, which corresponds to the designation of a device, is described. FIG. 1 shows an example of a device-adaptive format select OSD screen. FIG. 2 is a flow chart illustrating an example of the first adaptive data format setup process.

For example, if the remote-controller 102a transmits a display instruction for displaying the device-adaptive format select OSD screen, in accordance with the user's operation of the remote-controller 102a, the control module 104 receives, via the signal light-reception module 102, the display instruction for displaying the device-adaptive format select OSD screen, and a screen generation module 1041 controls the generation of the device-adaptive format select OSD screen.

The screen generation module 1041 controls the generation of the device-adaptive format select OSD screen, based on device-adaptive format select OSD screen generation information which is stored in the memory module 106. The communication module 103 can download the latest device-adaptive format select OSD screen generation information from the server 202 via the network 201. Thereby, the memory module 106 can store the latest device-adaptive format select OSD screen generation information.

A screen display/select accept module 1042 controls the display of the device-adaptive format select OSD screen. The OSD control module 107 generates the device-adaptive format select OSD screen, based on the device-adaptive format select OSD screen generation information, and outputs the device-adaptive format select OSD screen to the mixing process module 109. Based on the OSD control of the OSD control module 107, the mixing process module 109 can output only the video of the device-adaptive format select OSD screen, can output video in which the video of the device-adaptive format select OSD screen is superimposed on the video of a predetermined program, or can output the video of a predetermined program and the video of the device-adaptive format select OSD screen. Thereby, the video display device M displays the device-adaptive format select OSD screen.

As shown in FIG. 1, the device-adaptive format select OSD screen includes the kind of device, the maker name of the device, and the model number of the device. For example, in the initial state, the device-adaptive format select OSD screen displays a list of the kinds of devices. If a predetermined device is selected from this device list display via the remote-controller 102a, the screen display/select accept module 1042 accepts the selection of the predetermined device. Subsequently, the device-adaptive format select OSD screen displays a list of maker names of the selected predetermined device. If a predetermined maker name is selected from the maker name list display via the remote-controller 102a, the screen display/select accept module 1042 accepts the selection of the predetermined maker name, and subsequently the device-adaptive format select OSD screen displays a list of model numbers of the predetermined maker name of the predetermined device. If a predetermined model number is selected from the model number list display via the remote-controller 102a, the screen display/select accept module 1042 accepts the selection of the predetermined model name, and the designation of the device is completed (BLOCK 101).

Following the above, an adaptive-format registration module 1043 refers to a correspondency table stored in the memory module 106, searches an adaptive data format which corresponds to the designated device (model number), and sets the adaptive data format which corresponds to the designated device (model number) (Yes in BLOCK 102) (BLOCK 103).

FIG. 4 shows an example of the correspondency table. As shown in FIG. 4, for example, a terminal A (model number A) is associated with a format A, a terminal B (model number B) is associated with a format B, and a terminal C (model number C) is associated with a format C. In other words, the terminal A (model number A) supports the format A, the terminal B (model number B) supports the format B, and the terminal C (model number C) supports the format C.

Thus, when the designated device (model number) is the terminal A (device A), the adaptive-format registration module 1043 refers to the correspondency table stored in the memory module 106, and sets the format A. When the designated device (model number) is the terminal B (device B), the adaptive-format registration module 1043 refers to the correspondency table stored in the memory module 106, and sets the format B. When the designated device (model number) is the terminal C (device C), the adaptive-format registration module 1043 refers to the correspondency table stored in the memory module 106, and sets the format C.

If the memory module 106 does not store the correspondency table (No in BLOCK 102), or if the correspondency table stored in the memory module 106 is old (i.e. if the correspondency table has not been updated for a period longer than a predetermined period), an expansion table acquisition module 1044 downloads a correspondency table (expansion table) from the server 202 via the communication module 103 (BLOCK 104), and updates the correspondency table in the memory module 106 to the latest correspondency table. Thereby, the adaptive-format registration module 1043 can refer to the latest correspondency table stored in the memory module 106, and can search and set an adaptive data format which corresponds to the designated device (model number), and sets the adaptive data format which corresponds to the designated device (model number) (BLOCK 103).

Alternatively, when the memory module 106 does not store the correspondency table (No in BLOCK 102), the adaptive-format registration module 1043 sets a default format (BLOCK 104).

In the above description, the case has been described in which the number of adaptive data formats, which correspond to the designated device, is one. However, the number of adaptive data formats, which correspond to the designated device, may be two or more.

Next, a first data recording process by the adaptive data format is described.

In accordance with the user's instruction for program recording, the control module 104 executes a first data recording process by an adaptive data format. Specifically, an adaptive format data recording/output module 1045 executes control to record input data (video stream data) by an adaptive data format. Thus, simply by the user designating the device (e.g. mobile terminal 302) in advance, as described above, the adaptive format data recording/output module 1045 executes control to record content in a designated medium (SD card 301) by an adaptive data format which is supported by the designated device (e.g. mobile terminal 302).

In accordance with this, the recording/reproducing signal processing module 108 converts the content data to the adaptive data format, and outputs the content data of the adaptive data format to, e.g. the SD card 301. Thus, the content data of the adaptive data format is recorded in the SD card 301.

For example, simply by loading the SD card 301 in the mobile terminal 302, the user can surely view, with the mobile terminal 302, the content data (the content data of the adaptive data format) which is recorded in the SD card 301.

In the above description, the case has been described in which the content data of the adaptive data format is recorded in the SD card 301. Alternatively, the content data of the adaptive data format may be recorded on the hard disk. In this case, for example, the video recording/reproducing apparatus 1 and the mobile terminal 302 are connected by, e.g. a USB, and the content data of the adaptive data format, which is recorded on the hard disk of the video recording/reproducing apparatus 1, can be copied or moved from the video recording/reproducing apparatus 1 to the mobile terminal 302 by an operation such as a drag-and-drop operation.

In this case, too, by a simple operation such as a drag-and-drop operation, the user can surely view the content data (the content data of the adaptive data format) by the mobile terminal 302.

In the above description, the case has been described in which the recording/reproducing signal processing module 108 converts the content data to one adaptive data format, and records the converted content data of the adaptive data format. Alternatively, when a plurality of adaptive data formats are set, the recording/reproducing signal processing module 108 may convert the content data to the plural adaptive data formats, and records the converted content data of the plural adaptive data formats.

In the meantime, after content data is recorded by a standard data format (default data format), the device designation process and the first adaptive data format setup process may be executed, and thereafter the first data recording process may be executed. Specifically, in accordance with the user's instruction for program recording, the control module 104 executes control to record the content data by the standard format (first data format). In accordance with this, for example, the hard disk drive module 111 records the content data of the standard data format on the hard disk. Subsequently, if the device designation process is executed, the first adaptive data format setup process is executed, the first data recording process is executed, the content data of the standard data format (first data format) recorded on the hard disk is converted to content data of the adaptive data format (second data format), and the converted content data of the adaptive data format is recorded.

### Second Embodiment

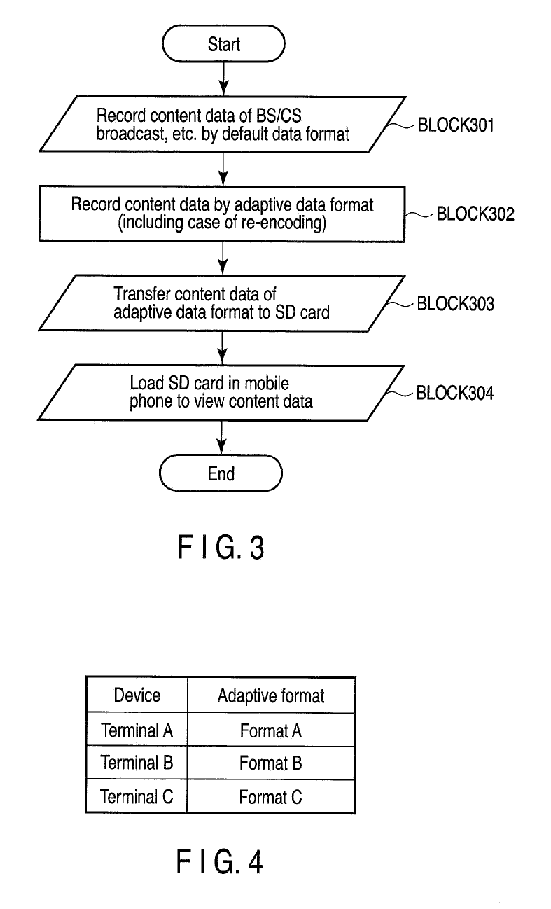

In the first embodiment, the first data recording process, which records content data by the adaptive data format, has been described. In the second embodiment, a description is given of a second data recording process which records content data by both the standard data format (first data format) and the adaptive data format (second data format). FIG. 3 is a flow chart illustrating an example of the second data recording process which records content data by both the standard data format and the adaptive data format.

As shown in FIG. 3, in accordance with the user's instruction for program recording, the control module 104 executes the second data recording process by the standard data format and the adaptive data format. Specifically, the adaptive format data recording/output module 1045 executes control to record input data (content data) by the standard data format and the adaptive data format. Thus, simply by the user designating the device (e.g. mobile terminal 302) in advance, as described above, the adaptive format data recording/output module 1045 executes control to record content data in a designated medium (e.g. hard disk) by the standard data format, and also executes control to record content in a designated medium (e.g. hard disk or SD card 301) by the data format which is supported by the designated device (e.g. mobile terminal 302).

In accordance with this, the recording/reproducing signal processing module 108 converts the content data to the standard data format, and the hard disk drive module 111, for example, records the content data of the standard data format on the hard disk. Further, the recording/reproducing signal processing module 108 converts the content data to the adaptive data format, and the hard disk drive module 111, for example, records the content data of the adaptive data format on the hard disk (BLOCK 301) (BLOCK 302).

Alternatively, the recording/reproducing signal processing module 108 converts the content data to the standard data format, and the hard disk drive module 111, for example, records the content data of the standard data format on the hard disk. Further, the recording/reproducing signal processing module 108 converts the content data to the adaptive data format, and outputs the content data of the adaptive data format to the SD card 301.

When the content data of the adaptive data format is recorded on the hard disk, the recording/reproducing signal processing module 108 transfers the content data of the adaptive data format, which is recorded on the hard disk, to the SD card 301, for example, in accordance with a data transfer instruction by the user (BLOCK 303). Accordingly, the content data of the standard data format is recorded on the hard disk, and the content data of the adaptive data format is recorded in the SD card 301. In the meantime, it is assumed that the recording/reproducing signal processing module 108 can reproduce recorded data which is recorded, at least, by the standard data format.

For example, simply by loading the SD card 301 in the mobile terminal 302, the user can surely view, with the mobile terminal 302, the content data (the content data of the adaptive data format) which is recorded in the SD card 301 (BLOCK 304). Moreover, the user can view, with the video recording/reproducing apparatus 1, the content data (the content data of the standard data format) which is recorded in the hard disk drive.

### Third Embodiment

In the second embodiment, the second data recording process, which records content data by both the standard data format (first data format) and adaptive data format (second data format), has been described. In the third embodiment, a description is given of a third data recording process which records content data by the standard data format (first data format) and the adaptive data format (second data format) at the same timing, and a fourth data recording process which records content data by the standard data format (first data format) and the adaptive data format (second data format) at different timings.

As described above, the control module 104 executes the third data recording process by the standard data format and adaptive data format. For example, the adaptive format data recording/output module 1045 executes control to record content data by both the standard data format and the adaptive data format at the same timing. Thereby, immediately after the recording of the content data, the content data of the adaptive data format can be used.

Alternatively, the control module 104 executes the fourth data recording process by the standard data format and adaptive data format. For example, the adaptive format data recording/output module 1045 executes control to record content data by both the standard data format and the adaptive data format at different timings. For example, the adaptive format data recording/output module 1045 preferentially executes the recording of content data by the standard data format, and executes, after the completion of the recording of content data by the standard data format, the recording of content data by the adaptive data format. For example, the adaptive format data recording/output module 1045 executes the recording of content data by the adaptive data format in a designated time zone (late-night time zone). Thereby, even if the processing capability of the recording/reproducing signal processing module 108, etc. is low, it becomes possible to record the content data by a plurality of adaptive data formats. Moreover, since the recording/reproducing signal processing module 108 has an excess capability while recording the content data of the standard data format, the recording/reproducing signal processing module 108 can execute a parallel process, such as reproducing other content data.

Aside from the above, content data of an adaptive data format may be prepared in a manner as described below. For example, if the control module 104 detects, for example, additional recording of new content data (content data of the standard data format), the adaptive format data recording/output module 1045 may generate and record content data of an adaptive data format corresponding to the new content data. Thereby, both the standard data format and the adaptive data format are prepared for all content data, and the convenience is enhanced.

### Fourth Embodiment

In the first embodiment, the first adaptive data format setup process corresponding to the designation of the device has been described. In the fourth embodiment, a description is given of a second adaptive data format setup process corresponding to the designation of the device and the designation of the data format.

For example, in the case where the device A has been designated through the device-adaptive format select OSD screen shown in FIG. 1 and the device A supports a format A1 and a format A2, the device-adaptive format select OSD screen displays a select item for selecting one adaptive data format from a plurality of candidate data formats (format A1 and format A2). If the user selects the format A1, the screen display/select accept module 1042 accepts the selection of the format A1 and the adaptive-format registration module 1043 sets the format A1. If the user selects the format A2, the screen display/select accept module 1042 accepts the selection of the format A2 and the adaptive-format registration module 1043 sets the format A2. Thereby, when one device supports a plurality of data formats (i.e. when one device can reproduce data of a plurality of data formats), the adaptive data format can be set in accordance with the user's preference.

In the meantime, the adaptive-format registration module 1043 may preferentially (automatically) set either the format A1 or the format A2. In other words, even in the case where the user has designated the device A, and the device A supports the format A1 and format A2, the adaptive-format registration module 1043 preferentially (automatically) sets either the format A1 or the format A2.

According to the above-described first to fourth embodiments, simply by the user designating a device on the GUI screen, the video recording/reproducing apparatus 1 sets the adaptive data format which is adaptive to the designated device, converts content data to the adaptive data format, and records the content data of the adaptive data format. Specifically, the video recording/reproducing apparatus 1 does not record content data by converting the content data to a designated data format, but the video recording/reproducing apparatus 1 records content data by converting the content data to an adaptive data format which is adaptive to a designated device. Even if the user is not familiar with data formats, it is possible to obtain data of an adaptive data format which is adaptive to a device that is to be used by the user.

In the above-described first to fourth embodiments, the transcode by the video recording/reproducing apparatus 1 has been described. However, for example, the video recording/reproducing apparatus 1 can re-encode MPEG2 content data of BS/CS broadcast to content data of MPEG4AVC for smartphones.

The first to fourth embodiments may be summarized as follows.

(1) The video recording/reproducing apparatus 1 can convert, at the same timing, content data to the standard data format (first data format) and the adaptive data format (second data format) that is adaptive to the designated device, and can record, at the same timing, the content data of the standard data format and the content data of the adaptive data format.

(2) The video recording/reproducing apparatus 1 can convert, at different timings based on a predetermined event, content data to the standard data format (first data format) and the adaptive data format (second data format) that is adaptive to the designated device, and can record, at different timings based on a predetermined event, the content data of the standard data format and the content data of the adaptive data format.

Thus, for example, when the user possesses a smartphone, the user can obtain content data of an adaptive data format which is reproducible by the smartphone, simply by designating this smartphone in the video recording/reproducing apparatus 1. In other words, the video recording/reproducing apparatus 1 records content data by an adaptive data format which is supported by a designated smartphone. The content data of the adaptive data format, which has been recorded by the video recording/reproducing apparatus 1, can be moved to the smartphone by wire, or wirelessly, or via recording media. Thereby, the content data can surely be viewed by the smartphone.

The above-described modules may be realized by hardware, or by software with use of a CPU, etc.

The various modules of the embodiments described herein can be implemented as software applications, hardware and/or software modules, or components on one or more computers, such as servers. While the various modules are illustrated separately, they may share some or all of the same underlying logic or code.

All of the processes described above may be embodied in, and fully automated via, software code modules executed by one or more general purpose or special purpose computers or processors. The code modules may be stored on any type of computer-readable medium or other computer storage device or collection of storage devices. Some or all of the methods may alternatively be embodied in specialized computer hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recording control apparatus comprising:
a setup module configured to set, based on a device designation, an adaptive data format, the adaptive data format adaptive to the designated device; and
a controller configured to record input data based on the adaptive data format.

2. The apparatus of claim 1, further comprising:
a reproducer configured to reproduce recorded data, the recorded data in a standard data format,
wherein the setup module is configured to set the standard data format and wherein the controller is configured to record the input data from the standard data format based on the adaptive data format.

3. The apparatus of claim 1, further comprising:
a recorder configured to record input data in the adaptive data format based on the controller.

4. The apparatus of claim 1, wherein the controller is configured to record video stream data based on the adaptive data format.

5. The apparatus of claim 1, wherein the setup module is configured to determine the adaptive data format which the designated device is capable of reproducing.

6. The apparatus of claim 1, wherein the setup module is configured to select, based on a data format select condition, the adaptive data format from a plurality of candidate data formats which the designated device is capable of reproducing.

7. The apparatus of claim 1, wherein the setup module is configured to output information relating to a plurality of candidate data formats which the designated device is capable of reproducing, and to set the adaptive data format which is selected from the plurality of candidate data formats.

8. The apparatus of claim 2, wherein the controller is configured to record the input data by the standard data format, and to record the input data based on the adaptive data format after completion of the input data recording based on the standard data format.

9. A recording control method comprising:
setting, in accordance with designation of a device, an adaptive data format which is adaptive to the designated device; and
executing control to record input data based on the adaptive data format.
